(19) United States
(12) Patent Application Publication
(10) Pub. No.: US 2021/0097374 A1
(43) Pub. Date: Apr. 1, 2021

(54) PREDICTING SEARCH INTENT

(71) Applicant: Microsoft Technology Licensing, LLC, Redmond, WA (US)

(72) Inventors: Xiaowei Liu, Mountain View, CA (US); Yu Gan, Mountain View, CA (US); Huiji Gao, Sunnyvale, CA (US); Bo Long, Palo Alto, CA (US)

(73) Assignee: Microsoft Technology Licensing, LLC, Redmond, WA (US)

(21) Appl. No.: 16/588,767

(22) Filed: Sep. 30, 2019

(51) Int. Cl. G06N 3/04; G06F 16/2457; G06N 3/08

(52) U.S. Cl. CPC G06N 3/0472; G06N 3/08; G06F 16/24578

(57) ABSTRACT

The disclosed embodiments provide a system for processing a search query. During operation, the system generates, based on one or more embedding layers in a machine learning model, input embeddings of the search query from a user of an online system. Next, the system applies one or more convolution layers in the machine learning model to the input embeddings to generate convolutional output from combinations of the input embeddings. The system then processes the convolutional output using one or more prediction layers in the machine learning model to produce a set of intent scores representing predicted likelihoods of a set of search intentions in the search query. Finally, the system performs a search of one or more verticals in the online system based on the search query and the set of intent scores.

### BACKGROUND

### Field

The disclosed embodiments relate to processing searches. More specifically, the disclosed embodiments relate to techniques for predicting search intent.

### Related Art

Online networks commonly include nodes representing individuals and/or organizations, along with links between pairs of nodes that represent different types and/or levels of social familiarity between the entities represented by the nodes. For example, two nodes in an online network are connected as friends, acquaintances, family members, classmates, and/or professional contacts. Online networks may further be implemented and/or maintained on web-based networking services, such as online networks that allow the individuals and/or organizations to establish and maintain professional connections, list work and community experience, endorse and/or recommend one another, promote products and/or services, and/or search and apply for jobs.

In turn, online networks may facilitate activities related to business, recruiting, networking, professional growth, and/or career development. For example, professionals use an online network to locate prospects, maintain a professional image, establish and maintain relationships, and/or engage with other individuals and organizations. Similarly, recruiters use the online network to search for candidates for job opportunities and/or open positions. At the same time, job seekers use the online network to enhance their professional reputations, conduct job searches, reach out to connections for job opportunities, and apply to job listings. Consequently, use of online networks may be increased by improving the data and features that can be accessed through the online networks.

### BRIEF DESCRIPTION OF THE FIGURES

FIG. 1 shows a schematic of a system in accordance with the disclosed embodiments.

FIG. 2 shows a system for processing searches in accordance with the disclosed embodiments.

FIG. 3 shows an example machine learning model in accordance with the disclosed embodiments.

FIG. 4 shows a flowchart illustrating the processing of a search query in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for processing searches. In these embodiments, an online system includes multiple verticals that return different types of search results in response to the searches. For example, an online network includes verticals that search for and/or retrieve information related to people, jobs, companies, schools, groups, events, videos, audio, images, content, sales, marketing, hiring, educational technology, and/or other entities in the online network.

More specifically, the disclosed embodiments provide a method, apparatus, and system for predicting search intention. Each search intention represents a type of search to be performed using a given query. For example, each search intention represents a vertical in the online system with which searches can be performed. In the context of an online network, search intentions and/or verticals include, but are not limited to, people, jobs, companies, content, schools, groups, hiring, sales, marketing, and/or other products offered by or through the online network.

To predict an intention of a given search query, a representation of the search query is inputted into a machine learning model, along with features representing the user performing the search. For example, the machine learning model includes one or more embedding layers that convert tokens, keywords, phrases, and/or other components of the search query into input embeddings in a lower-dimensional vector space. The machine learning model also includes one or more convolutional layers that generate convolutional output from various combinations of the input embeddings. The machine learning model further includes one or more prediction layers that convert the convolutional output into intent scores representing predicted likelihoods of individual search intentions in the search query.

In some embodiments, input to the machine learning model also includes features related to previous activity and/or searches by the user. For example, the features include the user's historical views of entities in the online system, historical actions related to the entities, responsiveness to messages from or related to a certain type of entity, behavioral intent, and/or user segment. The features also, or instead, include historical searches of the user with one or more verticals in the online system and/or recent search behavior of the user. The features can be inputted into the prediction layers of the machine learning model to provide additional context related to the user's search query. In turn, the machine learning model is able to use the features to infer the user's search intent in ambiguous queries.

The predicted search intentions are then used to perform one or more tasks related to the search query. For example, a search of each of the verticals is performed using the search query, and multiple sets of search results from the verticals are combined into a ranking. To generate the ranking, an additional machine learning model is applied to the search results and intent scores for the corresponding verticals to generate ranking scores representing the relevance of each search result to the user and/or the likelihood of a positive outcome between the user and each search result. The search results are ranked by descending ranking score, and a set of rules is used to filter, reorder, and/or otherwise update the ranking. A subset of the highest-ranked search results is then outputted in response to the search query.

In another example, the search intentions are used to process a natural language query from the user (e.g., by converting the natural language query into search parameters for each vertical represented by a search intention identified in the natural language query and performing a search of the vertical using the search parameters). In a third example, the search intentions are used to generate a response (e.g., by a chatbot or virtual assistant) to conversational input from the user.

By inferring search intentions based on convolutions of embeddings generated from search queries by users, the disclosed embodiments are able to extract and encode complex semantics that improve the accuracy of the inferences. The embeddings can also be used as semantic representations of the search queries, users, and/or search intents, which reduces the amount of memory or storage consumed by representations of the search queries, users, and/or search intents and improves processing of the search queries in contexts such as natural language search and/or generating responses to conversational input. Generation of search results based on the search intentions additionally increases the relevance of the search results to the users, which improves the users' engagement with the online system and/or reduces the amount of searching, browsing, filtering, and/or sorting performed by the users to find relevant content on the online system. In turn, the computational load of the online system is reduced, which allows the online system to support a greater number of users and/or perform additional tasks.

In contrast, conventional techniques utilize business rules and/or simpler linear models to predict search intent. These business rules and/or linear models fail to capture semantic nuance and/or behavioral context associated with search queries, thus reducing the accuracy of the predictions. Because search results generated based on these predictions include content that is irrelevant to the users' real search intentions, the users may be required to repeatedly reformulate the searches and/or perform additional browsing, filtering, and/or sorting to access content that is relevant to the real search intentions. In turn, additional computational overhead is incurred in processing the additional searching, browsing, filtering, and/or sorting, which reduces the online system's bandwidth and/or ability to perform other types of processing. Consequently, the disclosed embodiments improve computer systems, applications, user experiences, tools, and/or technologies related to performing and/or processing online searches and/or other types of user input.

### Predicting Search Intent

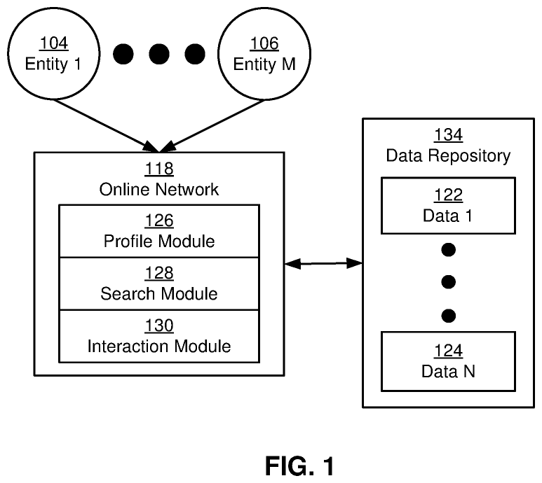

FIG. 1 shows a schematic of a system in accordance with the disclosed embodiments. As shown in FIG. 1, the system includes an online network 118 and/or other user community. For example, online network 118 includes an online professional network that is used by a set of entities (e.g., entity 1 104, entity x 106) to interact with one another in a professional and/or business context.

The entities include users that use online network 118 to establish and maintain professional connections, list work and community experience, endorse and/or recommend one another, search and apply for jobs, and/or perform other actions. The entities also, or instead, include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 also allows the entities to view the profiles of other entities in online network 118.

Profile module 126 also, or instead, includes mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other information maintained by online network 118. For example, the entities input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that provides the entities the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 is logged and stored in a database, data warehouse, cloud storage, and/or other data-storage mechanism providing data repository 134.

In one or more embodiments, search module 128 and/or online network 118 include functionality to process searches by members of online network 118 based on predictions of search intentions in the searches. As described in further detail below, the predicted search intentions are generated based on embeddings of the searches, convolutions of sequences of the embeddings, and/or additional features representing the members' historical or recent actions, searches, and/or user segments. The predicted search intentions thus account for complex semantics and/or behavioral contexts associated with the searches, which improves subsequent generation of search results for the searches and/or interactions with the members.

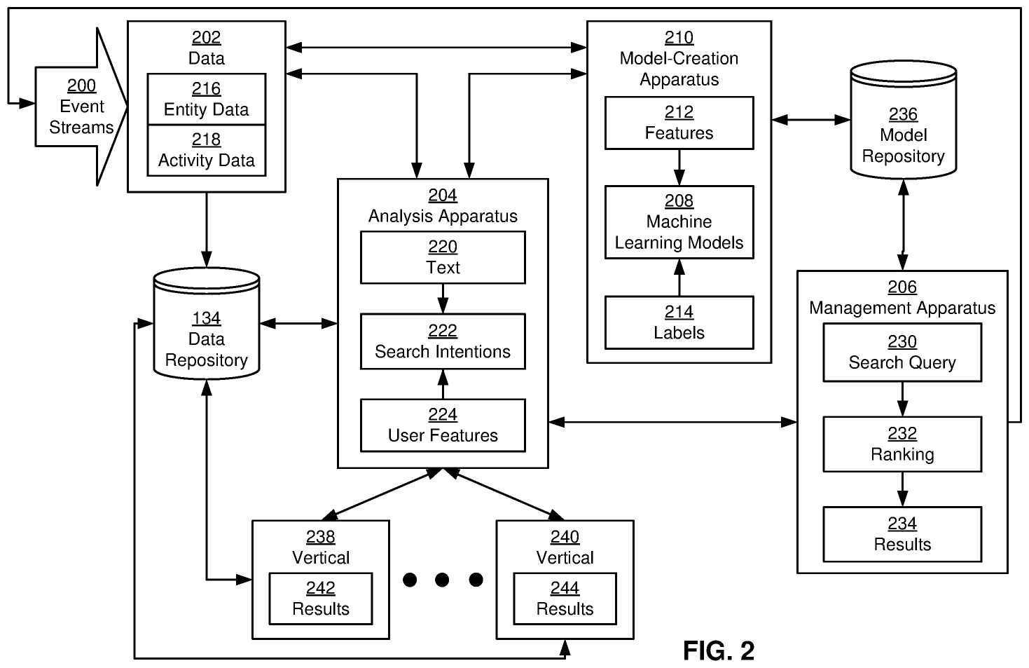

FIG. 2 shows a system for processing searches in accordance with the disclosed embodiments. In some embodiments, the system is implemented using search module 128 and/or other components of online network 118 of FIG. 1. The system includes an analysis apparatus 204, a model-creation apparatus 210, and a management apparatus 206. Each of these components is described in further detail below.

In one or more embodiments, the system processes search queries (e.g., search query 230) from users of an online system (e.g., online network 118 of FIG. 1) using data in data repository 134. As shown in FIG. 2, data 202 includes entity data 216 related to entities in the online system, as well as activity data 218 that logs activity related to the entities within and/or outside the online system.

Entity data 216 includes attributes associated with entities in the online system. For example, entities in an online professional network include people, companies, schools, groups, jobs, posts, articles, advertisements, events, educational technology courses, images, audio, video, locations, and/or other representations of data 202 and/or content in the online professional network.

Continuing with the above example, attributes associated with people include profile data for members of the online system, such as demographic (e.g., gender, age range, nationality, location, language), professional (e.g., job title, professional summary, professional headline, employer, industry, experience, skills, seniority level, professional endorsements), social (e.g., organizations to which the user belongs, geographic area of residence), and/or educational (e.g., degree, university attended, certifications, licenses) attributes. Attributes associated with jobs include the jobs' functions, roles, titles, industries, seniorities, locations, required skills, responsibilities, salary ranges, benefits education levels, and/or other fields that describe or are related to the jobs.

In some embodiments, attributes of people, jobs, and/or other entities are matched to a number of segments, with each segment containing a group of entities that share one or more common attributes. For example, member segments in the online system are defined to include members with the same industry, title, location, language, and/or income range. In another example, job segments of jobs in the online system include groups of jobs that share the same attributes. These job attributes include, but are not limited to, locations or regions of the jobs (e.g., states within the United States); languages, industries, seniorities, education, experience levels, skills, and/or titles associated with the jobs; sources of applications for the jobs (e.g., a jobs module or other onsite source within the online system or a company website or another offsite source that is external to the online system); and/or payment models for the jobs (e.g., pay per click (PPC) or a prepaid fixed price throughout the job's lifetime).

Connection information in entity data 216 is optionally combined into a graph, with nodes in the graph representing entities (e.g., users, schools, companies, locations, etc.) in the online system. Edges between the nodes in the graph represent relationships between the corresponding entities, such as connections between pairs of members, education of members at schools, employment of members at companies, following of a member or company by another member, business relationships and/or partnerships between organizations, and/or residence of members at locations.

Activity data 218 includes records of interactions among users, entities, and/or content associated with the online system. For example, activity data 218 logs impressions, clicks, likes, dislikes, shares, hides, comments, posts, updates, conversions, and/or other user interaction with content in the online system. Activity data 218 also, or instead, logs other types of activity, including connections, messages, job applications, job searches, recruiter searches for candidates, federated searches, interaction between candidates and recruiters, and/or interaction with groups or events. In some embodiments, activity data 218 further includes social validations of skills, seniorities, job titles, and/or other profile attributes, such as endorsements, recommendations, ratings, reviews, collaborations, discussions, articles, posts, comments, shares, and/or other member-to-member interactions that are relevant to the profile attributes. Activity data 218 additionally includes schedules, calendars, and/or upcoming availabilities of the users, which may be used to schedule meetings, interviews, and/or events for the users. Like entity data 216, activity data 218 is optionally used to create a graph, with nodes in the graph representing entities and/or content and edges between pairs of nodes indicating actions taken by the entities, such as creating or sharing articles or posts, sending messages, sending or accepting connection requests, endorsing or recommending one another, writing reviews, applying to opportunities, joining groups, and/or following other entities.

In one or more embodiments, some or all entity data 216, activity data 218, and/or other data 202 in data repository 134 is standardized before the data is used by components of the system. For example, skills associated with member profiles, jobs, courses, and/or other entities are organized into a hierarchical taxonomy that is stored in data repository 134 and/or another repository. The taxonomy models relationships between skills (e.g., “Java programming” is related to or a subset of “software engineering”) and/or standardize identical or highly related skills (e.g., “Java programming,” “Java development,” “Android development,” and “Java programming language” are standardized to “Java”).

In another example, locations in data repository 134 include cities, metropolitan areas, states, countries, continents, and/or other standardized geographical regions. Like standardized skills, the locations can be organized into a hierarchical taxonomy (e.g., cities are organized under states, which are organized under countries, which are organized under continents, etc.).

In a third example, data repository 134 includes standardized company names for a set of known and/or verified companies associated with the members and/or jobs. In a fourth example, data repository 134 includes standardized titles, seniorities, and/or industries for various jobs, members, and/or companies in the online system. In a fifth example, data repository 134 includes standardized time periods (e.g., daily, weekly, monthly, quarterly, yearly, etc.) that can be used to retrieve profile data 216, user activity 218, and/or other data 202 that is represented by the time periods (e.g., starting a job in a given month or year, graduating from university within a five-year span, job listings posted within a two-week period, etc.). In a sixth example, data repository 134 includes standardized job functions such as “accounting,” “consulting,” “education,” “engineering,” “finance,” “healthcare services,” “information technology,” “legal,” “operations,” “real estate,” “research,” and/or “sales.”

In some embodiments, standardized attributes in data repository 134 are represented by unique identifiers (IDs) in the corresponding taxonomies. For example, each standardized skill is represented by a numeric skill ID in data repository 134, each standardized title is represented by a numeric title ID in data repository 134, each standardized location is represented by a numeric location ID in data repository 134, and/or each standardized company name (e.g., for companies that exceed a certain size and/or level of exposure in the online system) is represented by a numeric company ID in data repository 134.

Data 202 in data repository 134 can be updated using records of recent activity received over one or more event streams 200. For example, event streams 200 are generated and/or maintained using a distributed streaming platform. One or more event streams 200 are also, or instead, provided by a change data capture (CDC) pipeline that propagates changes to data 202 from a source of truth for data 202. For example, an event containing a record of a recent profile update, job search, job view, job application, response to a job application, connection invitation, post, like, comment, share, and/or other recent member activity within or outside the online system is generated in response to the activity. The record is then propagated to components subscribing to event streams 200 on a nearline basis.

Management apparatus 206 includes functionality to receive a search query 230 from a user and/or recommend search query 230 to the user. For example, management apparatus 206 includes a user interface with a search field that allows the user to type in search query 230 and/or a voice user interface that converts the user's speech into a text-based representation of search query 230. Management apparatus 206 also, or instead, includes mechanisms for displaying or recommending search query 230 based on a partial query entered by the user (e.g., recommending “jobs at LinkedIn” or “people at LinkedIn” when the user inputs “LinkedIn” into the search field). Management apparatus 206 also or instead, generates search query 230 as a correction to a mistyped query (e.g., converting a query of “software enginer” into “software engineer”).

Analysis apparatus 204 analyzes text 220 in search query 230 to predict one or more search intentions 222 in search query 230. In some embodiments, search intentions 222 represent different types of searches that can be performed by the user. For example, search intentions 222 include entities that can be searched, such as people, jobs, companies, schools, groups, content, classes, events, and/or other types of entities with entity data 216 in data repository 134.

In some embodiments, some or all search intentions 222 represent individual verticals 238-240 in the online system. Continuing with the above example, search intentions 222 represent searches of products or features related to people, jobs, companies, schools, groups, events, content, sales, marketing, hiring, and/or educational technology in the online system.

More specifically, analysis apparatus 204 uses one or more machine learning models 208 to predict the presence or absence of individual search intentions 222 in text 220 of search query 230. For example, analysis apparatus 204 applies a logistic regression model, word embedding model, deep learning model, and/or another type of machine learning model to a bag-of-words, sequential, and/or embedded representation of text 220 in search query 230. The machine learning model outputs scores representing predicted likelihoods of search intentions 222 in text 220. In another example, analysis apparatus 204 applies multiple machine learning models 208 to text 220. Each machine learning model separately predicts the likelihood of a corresponding search intention in text 220. In both examples, a search intention is found in search query 230 when the search intention has a non-zero likelihood of occurring in text 220 and/or a likelihood of occurring in text 220 that is higher than a threshold.

Analysis apparatus 204 also includes functionality to infer search intentions 222 based on user features 224 of the user submitting search query 230. In one or more embodiments, user features 224 characterize previous activity and/or previous searches by the user. For example, user features 224 include the user's historical views of entities (e.g., profiles, companies, jobs, groups, schools, educational content, posts, etc.) in the online system and/or historical actions related to the entities (e.g., connection invitations, messages, following or unfollowing companies or schools, joining or leaving groups, etc.). User features 224 also, or instead, include the responsiveness of the user to a type of entity (e.g., the frequency of the user's responses to messages or communications related to career opportunities, job seeking, recruiting, sales, and/or other topics) and/or the user's interaction or level of activity with respect to different topics (e.g., education, entrepreneurship, finance, retail, technology, etc.). User features 224 also, or instead, indicate the behavioral intent of the user (e.g., by indicating whether the user has job-seeking, recruiting, or other intent) and/or a user segment of the user (e.g., whether or not the user is a business traveler and/or associated with a certain income range).

In another example, user features 224 include historical and/or recent search behavior of the user with one or more verticals 238-240 in the online system. The historical search behavior includes, but is not limited to, the user's views and/or actions related to job searches, company searches, group searches, school searches, content searches, educational technology searches, federated searches, and/or other types of searches supported and/or performed by verticals 238-240. The recent search behavior includes, but is not limited to, recent (e.g., within the same user session, in the last several hours, in the last day, etc.) search queries, search intentions, clicks on search results, switches between search verticals 238-240, query reformulations, and/or other search-related activity by the user. Consequently, user features 224 characterize the user's short- and long-term behavior, preferences, actions, and/or searches with respect to entities in the online system.

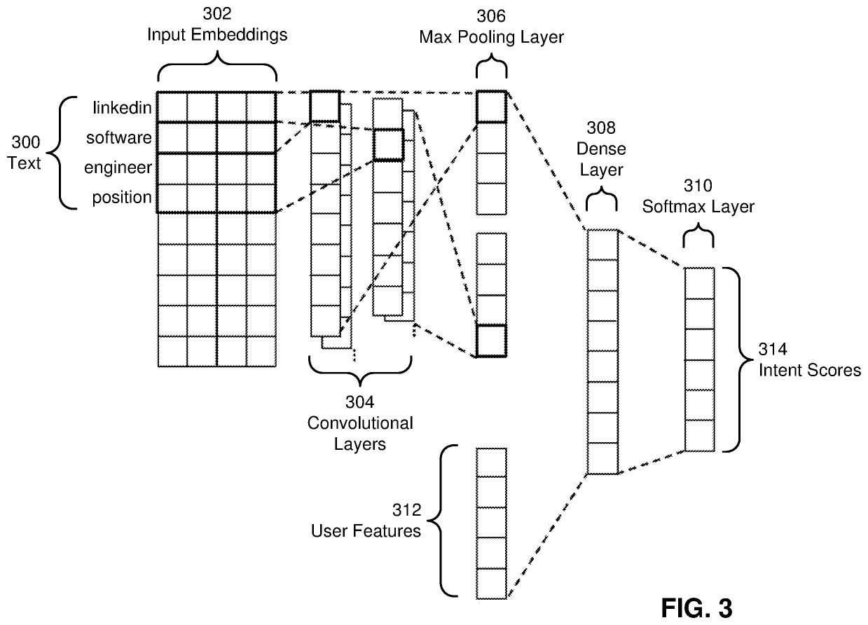

In one or more embodiments, machine learning models 208 include a convolutional neural network (CNN) that infers search intentions 222 based on text 220 of search query 230 and/or user features 224 of the user submitting search query 230. As shown in FIG. 3, an example machine learning model for predicting search intentions (e.g., search intentions 222 of FIG. 2) generates a set of input embeddings 302 from text 300 in a search query (e.g., search query 230 of FIG. 2). For example, input embeddings 302 include fixed-length vector representations of one-hot encoded tokens of “linkedin,” “software,” “engineer,” and “position” that make up the search query.

In some embodiments, input embeddings 302 are generated by one or more embedding layers (not shown) in the machine learning model. For example, input embeddings 302 include word2vec, Global Vectors for Word Representation (GloVe), FastText, Embeddings from language models (ELMo), and/or other types of embeddings generated by a pre-trained word embedding model. Input embeddings 302 are also, or instead, generated by embedding layers that are updated as the machine learning model is trained (e.g., after the embedding layers are initialized with parameters from the pre-trained word embedding model).

Next, a set of convolutional layers 304 apply various convolutional filters to input embeddings 302 to generate convolutional output from different combinations of input embeddings 302. For example, the convolutional filters have the same width, which is equal to the dimensionality of input embeddings 302. Conversely, the convolutional filters can vary in height (i.e., region size), such that a convolutional filter with a given height n is used to combine sequences of n input embeddings 302 into a corresponding feature map in the convolutional output. Thus, a size-2 convolutional filter is applied to input embeddings 302 for bigrams of “linkedin software,” “software engineer,” and “engineer position” in text 300 to produce a feature map with three elements. Similarly, a size-3 convolutional filter is applied to input embeddings 302 for trigrams of “linkedin software engineer” and “software engineer position” in text 300 to produce a feature map with two elements.

Feature maps generated by convolutional layers 304 are then pooled using a max pooling layer 306 in the machine learning model. For example, max pooling layer 306 selects the largest number from each feature map as a pooling result for the feature map and concatenates pooling results from all feature maps produced by convolutional layers 304 into a feature vector. If convolutional layers 304 include two size-3 convolutional filters and two size-3 convolutional filters, max pooling layer 306 pools feature maps outputted by the convolutional filters into a feature vector of size 4 (i.e., one element per feature map or convolutional filter).

The feature vector outputted by max pooling layer 306 is also concatenated with user features 312 for the user submitting the search query to produce input into a dense layer 308 in the machine learning model. For example, dense layer 308 includes a set of fully connected neurons with a rectified linear unit (ReLU) activation function, which provides additional nonlinearity to the processing performed by the machine learning model.

Finally, the output of dense layer 308 is inputted into a softmax layer 310 that generates intent scores 314 representing predicted likelihoods of different search intentions (e.g., people search, job search, content search, company search, group search, school search, educational technology search, etc.) in the search query. For example, softmax layer 310 generates, for each type of search intention, a value between 0 to 1 representing the probability that the search query includes the search intention. In addition, the set of values outputted by softmax layer 310 for a given search query sum to 1.

Returning to the discussion of FIG. 2, model-creation apparatus 210 creates and/or updates machine learning models 208 based on training data that includes features 212 and labels 214 from data repository 134 and/or another data store. Features 222 include samples of search queries previously submitted by users to the online system and/or attributes related to the users' short- and long-term behavior, preferences, and/or searches with respect to entities in the online system. Labels 214 include indications of search intentions related to the search queries. For example, a label representing a search intention of a historical search is generated when the user performing the historical search clicks on a search result generated by a vertical associated with the search intention.

In one or more embodiments, model-creation apparatus 210 uses features 212 representing historical searches and/or users performing the historical searches and labels 214 representing search intentions 222 to create and/or update one or more machine learning models 208 that predict search intentions 222 in the searches. For example, model-creation apparatus 210 inputs features 212 and the corresponding labels 214 into each machine learning model. Model-creation apparatus 210 then uses a training technique (e.g., gradient descent and backpropagation), a loss function (e.g., cross entropy), and/or one or more hyperparameters to update parameter values of machine learning models 208 so that predictions outputted by machine learning models 208 reflect the corresponding labels 214.

After machine learning models 208 are trained and/or updated, model-creation apparatus 210 stores parameters of machine learning models 208 in a model repository 236. For example, model-creation apparatus 210 replaces old values of the parameters in model repository 236 with the updated parameters, or model-creation apparatus 210 stores the updated parameters separately from the old values (e.g., by storing each set of parameters with a different version number of the corresponding machine learning model). In turn, analysis apparatus 204, management apparatus 206, and/or other components of the system retrieve the latest versions of machine learning models 208 from model-creation apparatus 210 and/or model repository 236 and use machine learning models 208 to predict search intentions 222 and/or other attributes of search query 230 or other search queries.

In one or more embodiments, analysis apparatus 204 and management apparatus 206 use predicted search intentions 222 of search query 230 to perform searches using verticals 238-240 represented by search intentions 222. For example, analysis apparatus 204 transmits text 220 and/or keywords extracted from search query 230 to verticals 238-240 with non-zero probabilities of search intentions 222 and/or probabilities of search intentions 222 that exceed a threshold. Next, analysis apparatus 204 receives, in response to the transmitted search query 230, search results 242-244 from verticals 238-240 containing content that matches text 220 and/or the keywords.

Analysis apparatus 204 optionally obtains an output embedding for search query 230 from one or more layers of machine learning models 208 and provides the output embedding to verticals 238-240 and/or other components involved in processing search query 230. For example, analysis apparatus 204 obtains the output embedding from dense layer 308 of the CNN of FIG. 3 and transmits the output embedding with text 220 to verticals 238-240. In turn, verticals 238-240 are able to generate results 242-244 based on an embedded representation of text 220, search intentions 222, and/or user features 224. Analysis apparatus 204 also, or instead, stores output embeddings of multiple search queries as representations of the corresponding search intentions 222, user features 224, and/or text 220 in the search queries in data repository 134 and/or another data store. The stored output embeddings can be used by other machine learning models and/or components to perform additional processing and/or inference related to the search queries and/or corresponding users.

Management apparatus 206 combines results 242-244 related to search query 230 from multiple verticals 238-240 into a ranking 232. In some embodiments, management apparatus 206 applies an additional machine learning model from model-creation apparatus 210 and/or model repository 236 to features related to results 242-244, search query 230, and/or the user to obtain a set of ranking scores for results 242-244. Each ranking score represents the relevance of each result to the user and/or search query 230 and/or the likelihood of a positive outcome between the user and each search result, given an impression of the search result by the user. Management apparatus 206 generates ranking 232 of results 242-244 by descending ranking score and uses a set of rules, filters, and/or exceptions to update ranking 232 (e.g., based on business requirements, user preferences, impression discounting, diversification of content, and/or other goals, strategies, or priorities).

In one or more embodiments, management apparatus 206 and/or the machine learning model optionally generate ranking 232 to reflect the predicted likelihoods of search intentions 222 in text 220 (e.g., so that search intentions 222 with higher predicted likelihoods have more results in ranking 232 and/or higher-ranked results in ranking 232 than search intentions 222 with lower predicted likelihoods). For example, a given search query 230 from the user includes predicted likelihoods of 0.6 for a job search intention and a predicted likelihood of 0.4 for a people search intention. As a result, management apparatus 206 populates 60% of ranking 232 and/or a certain number of positions in ranking 232 with results from a job search generated from text 220 and 40% of ranking 232 and/or a smaller number of positions in ranking 232 with results from a people search generated from text 220.

Finally, management apparatus 206 outputs some or all of ranking 232 as a final set of search results 234 for search query 230. For example, management apparatus 206 paginates portions of the updated ranking 232 into subsets of search results 234 that are displayed as the user scrolls through results 234 and/or navigates across screens or pages containing results 234. Subsequent responses and/or outcomes related to results 234 are, in turn, used to generate events that are fed back into the system (e.g., via event streams 200) and used to generate labels 214 and/or update machine learning models 208, search intentions 224, and/or results 234 for subsequent search queries.

In some embodiments, the system of FIG. 2 includes functionality to process other types of queries and/or user input based on predicted search intentions 222 for the user input. For example, analysis apparatus 204 and/or management apparatus 206 apply machine learning models 208 to a natural language query to predict search intentions 222 for the natural language query. Analysis apparatus 204 then converts the natural language query into search parameters for each vertical (e.g., verticals 238-240) represented by a search intention identified in the natural language query and performs a search of the vertical using the search parameters. Management apparatus 206 then combines results (e.g., results 242-244) of searches by the verticals into a ranking (e.g., ranking 232) and delivers some or all of the ranking as a final set of search results for the natural language query.

In another example, management apparatus 206 receives conversational input from a user during the user's interaction with a chatbot, virtual assistant, and/or another component with the capability to conduct a conversation with the user. Analysis apparatus 204 inputs some or all text 220 from the conversational input and/or user features 224 for the user into machine learning models 208 and obtains predictions of search intentions 222 as output from machine learning models 208. Analysis apparatus 204 then uses verticals 238-240 and/or other components to match text 220 and/or search intentions 222 to relevant content, and management apparatus 206 outputs some or all of the content in a response to the conversational input.

By inferring search intentions based on convolutions of embeddings generated from search queries by users, the disclosed embodiments are able to extract and encode complex semantics that improve the accuracy of the inferences. The embeddings can also be used as semantic representations of the search queries, users, and/or search intents, which reduces the amount of memory or storage consumed by representations of the search queries, users, and/or search intents and improves processing of the search queries in contexts such as natural language search and/or generating responses to conversational input. Generation of search results based on the search intentions additionally increases the relevance of the search results to the users, which improves the users' engagement with the online system and/or reduces the amount of searching, browsing, filtering, and/or sorting performed by the users to find relevant content on the online system. In turn, the computational load of the online system is reduced, which allows the online system to support a greater number of users and/or perform additional tasks. Consequently, the disclosed embodiments improve computer systems, applications, user experiences, tools, and/or technologies related to performing and/or processing online searches and/or other types of user input.

Those skilled in the art will appreciate that the system of FIG. 2 may be implemented in a variety of ways. First, analysis apparatus 204, model-creation apparatus 210, management apparatus 206, data repository 134, and/or model repository 236 may be provided by a single physical machine, multiple computer systems, one or more virtual machines, a grid, one or more databases, one or more filesystems, and/or a cloud computing system. Analysis apparatus 204, model-creation apparatus 210, and management apparatus 206 may additionally be implemented together and/or separately by one or more hardware and/or software components and/or layers.

Second, a number of models and/or techniques may be used to generate search intentions 222, output embeddings, and/or other data that is used in processing searches. For example, the functionality of machine learning models 208 may be provided by regression models, support vector machines, word embedding models, long short-term memory (LSTM) networks, recurrent neural networks, recursive neural networks, CNNs, transformers, tree-based models, and/or other types of models that process sequential data and/or text. Multiple versions of each machine learning model may be adapted to different search intentions 222, users, user segments, verticals 238-240, and/or types of search queries or user input, or the same machine learning model may be used to generate predictions of search intentions 222 in all search queries or user input to the online system. The retraining or execution of each machine learning model may further be performed on an offline, online, and/or on-demand basis to accommodate requirements or limitations associated with the processing, performance, or scalability of the system and/or the availability of features 212 and/or labels 214 used to train the machine learning model.

Third, the system of FIG. 2 may be adapted to different types of search queries, search intentions 222, and/or verticals 238-240. For example, the system may be used to process search queries of online systems with verticals related to different types of goods or services offered for sale through the online systems and/or different types of entertainment content (e.g., music, television shows, movies, games, etc.) hosted on the online systems.

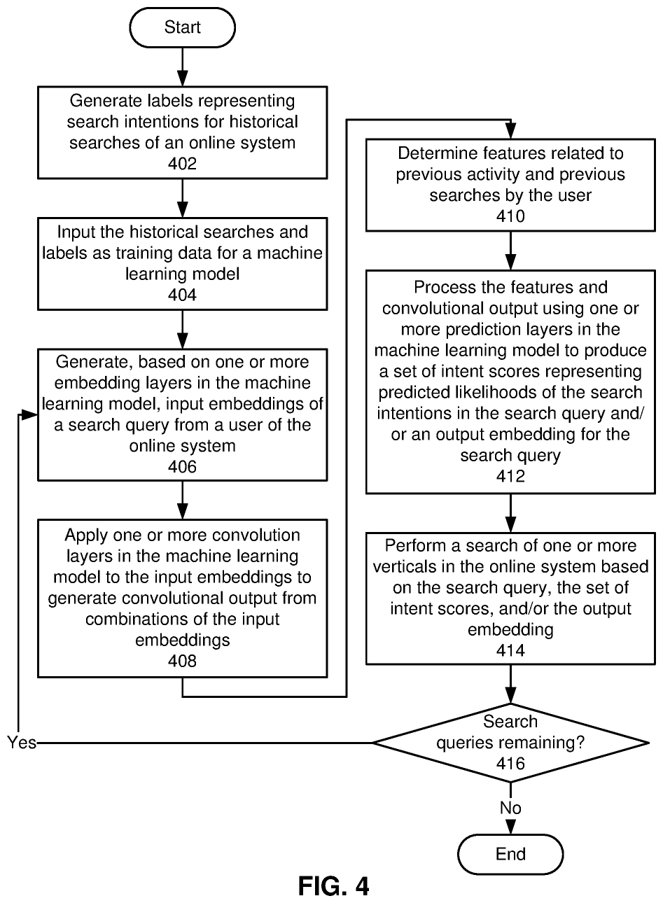

FIG. 4 shows a flowchart illustrating the processing of a search query in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, labels representing search intentions for historical searches of an online system are generated (operation 402) and inputted as training data for a machine learning model (operation 404). For example, each label represents a search intention of a historical search. The label is generated when a user clicks on a search result associated with the search intention (e.g., a search result generated by a vertical represented by the search intention) in a set of search results for the historical search. After the labels are generated for a set of historical searches, text and/or user features associated with the historical searches are inputted into the machine learning model, and parameters of the machine learning model are updated so that the output of the machine learning model better reflects the labels.

After the machine learning model is trained, the machine learning model can be used to predict search intentions for subsequent search queries. In particular, input embeddings of a search query from a user of the online system are generated based on one or more embedding layers in the machine learning model (operation 406). For example, the embedding layer(s) are used to convert one-hot encodings of tokens in the search query into corresponding input embeddings.

Next, one or more convolution layers in the machine learning model are applied to the input embeddings to generate convolutional output from combinations of the input embeddings (operation 408). For example, a first convolutional filter with a first size (e.g., height) is applied to sequences of the input embeddings (e.g., sequences with lengths that match the first size) to generate a first feature map, and a second convolutional filter with a second size that is larger than the first size is applied to longer sequences of the input embeddings (e.g., sequences with lengths that match the second size) to generate a second feature map. A pooling layer is then applied to the first and second feature maps to generate a first pooling result from the first feature map and a second pooling result from the second feature map.

Features related to previous activity and previous searches by the user are also determined (operation 410). For example, the features include historical views of entities in the online system, historical actions related to the entities, a responsiveness of the user to a type of entity, a behavioral (e.g., job seeking, recruiting, etc.) intent of the user, and/or a user segment of the user. The features also, or instead, include historical searches of the user with one or more verticals in the online system and/or recent search behavior of the user.

The features and convolutional output are processed using one or more prediction layers in the machine learning model to produce a set of intent scores representing predicted likelihoods of the search intentions in the search query and/or an output embedding for the search query (operation 412). For example, the prediction layers include dense layer 308 and softmax layer 310 in the machine learning model of FIG. 3. Dense layer 308 processes the pooled convolutional output and features to generate an output embedding for the search query, and softmax layer 310 processes the output embedding to generate the intent scores.

Finally, a search of one or more verticals in the online system is performed based on the search query, the set of intent scores, and/or the output embedding (operation 414). For example, a first search of a first vertical is performed using the search query and/or output embedding, and a second search of a second vertical is performed using the search query and/or output embedding. Another machine learning model is applied to features for the first and second sets of search results, which include a first intent score for the first vertical and the second intent score for the second vertical, to generate ranking scores for the first and second sets of search results. A ranking of the first and second sets of search results by the ranking scores is then generated, and at least a portion of the ranking is outputted in a response to the search query.

In another example, the intent scores are used to process a natural language query from the user by converting the natural language query into search parameters for each vertical represented by a search intention identified in the natural language query and performing a search of the vertical using the search parameters. In a third example, the search intentions are used to generate a response (e.g., by a chatbot or virtual assistant) to conversational input from the user.

Operation 406-414 may be repeated for remaining search queries (operation 416). For example, intent scores and/or output embeddings may be generated for all search queries and/or other types of search-related input to the online system (operations 406-412), and searches may be performed using the search queries, intent scores, and/or output embeddings (operation 414). Such processing of searches may continue until prediction of search intentions for the searches is no longer performed.

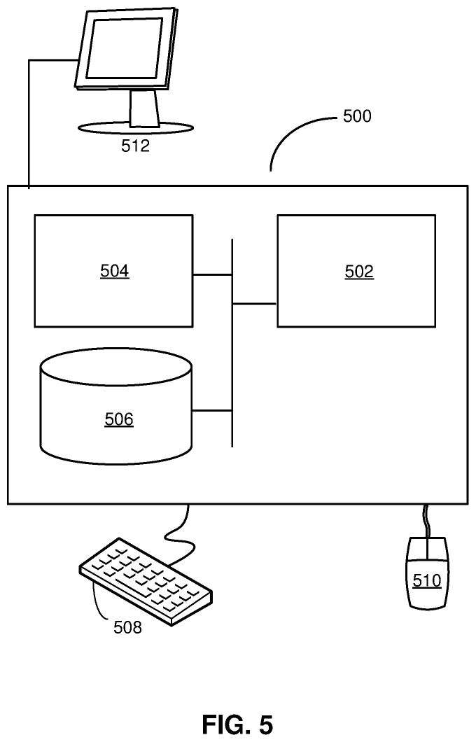

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for processing a search query. The system includes an analysis apparatus, a model-creation apparatus, and a management apparatus, one or more of which may alternatively be termed or implemented as a module, mechanism, or other type of system component. The model-creation apparatus generates labels representing the set of search intentions for historical searches of the online system and inputs the historical searches and the labels as training data for the machine learning model.

The analysis apparatus generates, based on one or more embedding layers in a machine learning model, input embeddings of the search query from a user of an online system. Next, the analysis apparatus applies one or more convolution layers in the machine learning model to the input embeddings to generate convolutional output from combinations of the input embeddings. The analysis apparatus then processes the convolutional output using one or more prediction layers in the machine learning model to produce a set of intent scores representing predicted likelihoods of a set of search intentions in the search query. Finally, the analysis apparatus and/or management apparatus perform a search of one or more verticals in the online system based on the search query and the set of intent scores.

In addition, one or more components of computer system 400 may be remotely located and connected to the other components over a network. Portions of the present embodiments (e.g., analysis apparatus, model-creation apparatus, management apparatus, data repository, model repository, online network, etc.) may also be located on different nodes of a distributed system that implements the embodiments. For example, the present embodiments may be implemented using a cloud computing system that generates search results for searches of a set of remote verticals.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used Implementation of these embodiments is not intended to supersede or interfere with the members' privacy settings.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
generating, by one or more computer systems based on one or more embedding layers in a machine learning model, input embeddings of a search query from a user of an online system;
applying, by the one or more computer systems, one or more convolution layers in the machine learning model to the input embeddings to generate convolutional output from combinations of the input embeddings;
processing, by the one or more computer systems, the convolutional output using one or more prediction layers in the machine learning model to produce a set of intent scores representing predicted likelihoods of a set of search intentions in the search query; and
performing, by the one or more computer systems, a search of one or more verticals in the online system based on the search query and the set of intent scores.

2. The method of claim 1, further comprising:
determining, based on data retrieved from a data store in an online system, features related to previous activity and previous searches by the user; and
processing the features using the one or more prediction layers to produce the set of intent scores.

3. The method of claim 2, wherein the features related to the previous activity by the user comprise at least one of:
historical views of entities in the online system;
historical actions related to the entities;
a responsiveness of the user to a type of entity;
a behavioral intent of the user; and
a user segment.

4. The method of claim 2, wherein the features related to the previous searches by the user comprise at least one of:
historical searches of the user with one or more verticals in the online system; and
recent search behavior of the user.

5. The method of claim 1, further comprising:
generating labels representing the set of search intentions for historical searches of the online system; and
inputting the historical searches and the labels as training data for the machine learning model.

6. The method of claim 5, wherein generating the labels for the historical searches of the online system comprises:
generating a label representing a search intention of a historical search based on a click on a search result associated with the search intention in a set of search results for the historical search.

7. The method of claim 1, wherein applying the one or more convolution layers to the input embeddings to generate the convolutional output comprises:
applying a first convolutional filter with a first size to sequences of the input embeddings to generate a first feature map in the convolutional output; and
applying a second convolutional filter with a second size that is larger than the first size to longer sequences of the input embeddings to generate a second feature map in the convolutional output.

8. The method of claim 7, wherein applying the one or more convolution layers to the input embeddings to generate the convolutional output further comprises:
applying a pooling layer to the first and second feature maps to generate a first pooling result from the first feature map and a second pooling result from the second feature map.

9. The method of claim 1, further comprising:
generating, by the one or more prediction layers, an output embedding for the search query from one or more layers of the machine learning model; and
performing the search of the one or more verticals based on the output embedding.

10. The method of claim 1, wherein performing the search of the one or more verticals in the online system based on the search query and the set of intent scores comprises:
performing a first search of a first vertical using the search query and a second search of a second vertical using the search query;
generating a ranking comprising a first set of search results for the first search and a second set of search results for the second search based on a first intent score for the first vertical and a second intent score for the second vertical; and
outputting at least a portion of the ranking in a response to the search query.

11. The method of claim 10, wherein generating the ranking comprising the first and second sets of search results based on the first and second intent scores comprises:
applying another machine learning model to additional features that comprise the first intent score and the second intent score to generate ranking scores for the first and second sets of search results; and
generating the ranking of the first and second sets of search results by the ranking scores.

12. The method of claim 1, wherein performing the search of the one or more verticals in the online system based on the search query and the set of intent scores comprises at least one of:
generating a result of a natural language query from the user based on the set of intent scores for the natural language query; and
generating a response to conversational input from the user based on the set of intent scores for the conversational input.

13. The method of claim 1, wherein the set of search intentions comprises at least one of:
a people search;
a job search;
a content search;
a company search;
a group search;
a school search; and
an educational technology search.

14. A system, comprising:
one or more processors; and
memory storing instructions that, when executed by the one or more processors, cause the system to:
generate, based on one or more embedding layers in a machine learning model, input embeddings of a search query from a user of an online system;
apply one or more convolution layers in the machine learning model to the input embeddings to generate convolutional output from combinations of the input embeddings;
process the convolutional output using one or more prediction layers in the machine learning model to produce a set of intent scores representing predicted likelihoods of a set of search intentions in the search query; and
perform a search of one or more verticals in the online system based on the search query and the set of intent scores.

15. The system of claim 14, wherein the memory further stores instructions that, when executed by the one or more processors, cause the system to:
determine, based on data retrieved from a data store in an online system, features related to previous activity and previous searches by the user; and
process the features using the one or more prediction layers to produce the set of intent scores.

16. The system of claim 14, wherein applying the one or more convolution layers to the input embeddings to generate the convolutional output comprises:
applying a first convolutional filter with a first size to sequences of the input embeddings to generate a first feature map in the convolutional output;
applying a second convolutional filter with a second size that is larger than the first size to longer sequences of the input embeddings to generate a second feature map in the convolutional output; and
applying a pooling layer to the first and second feature maps to generate a first pooling result from the first feature map and a second pooling result from the second feature map.

17. The system of claim 14, wherein performing the search of the one or more verticals in the online system based on the search query and the set of intent scores comprises:
performing a first search of a first vertical using the search query and a second search of a second vertical using the search query;
generating a ranking comprising a first set of search results for the first search and a second set of search results for the second search based on a first intent score for the first vertical and a second intent score for the second vertical; and
outputting at least a portion of the ranking in a response to the search query.

18. The system of claim 17, wherein generating the ranking comprising the first and second sets of search results based on the first and second intent scores comprises:
applying another machine learning model to additional features that comprise the first intent score and the second intent score to generate ranking scores for the first and second sets of search results; and
generating the ranking of the first and second sets of search results by the ranking scores.

19. The system of claim 14, wherein processing the convolutional output using one or more prediction layers in the machine learning model comprises:
applying a dense layer to the convolutional output to generate an output embedding for the search query; and
applying a softmax layer to the output embedding to generate the set of intent scores.

20. A non-transitory computer-readable storage medium storing instructions that when executed by a computer cause the computer to perform a method, the method comprising:
generating, based on one or more embedding layers in a machine learning model, input embeddings of a search query from a user of an online system;
applying one or more convolution layers in the machine learning model to the input embeddings to generate convolutional output from combinations of the input embeddings;
processing the convolutional output using one or more prediction layers in the machine learning model to produce a set of intent scores representing predicted likelihoods of a set of search intentions in the search query; and
performing a search of one or more verticals in the online system based on the search query and the set of intent scores.
